(19) United States
(12) Patent Application Publication
(10) Pub. No.: US 2005/0136269 A1
(43) Pub. Date: Jun. 23, 2005

(54) Polysiloxanes containing (meth)acrylic ester groups attached via SiOC groups, processes for preparing them and their use as a radiation-curable abhesive coating

(76) Inventors: Hardi Doehler, Hattingen (DE); Jutta Esselborn, Essen (DE); Sascha Herrwerth, Essen (DE); Thomas Neumann, Bochum (DE)

Correspondence Address: FROMMER LAWRENCE & HAUG LLP, 745 Fifth Avenue, New York, NY, 10151, US

(21) Appl. No.: 11/013,639

(22) Filed: Dec. 16, 2004

(30) Foreign Application Priority Data
Dec. 19, 2003 (DE) 103 59 764.6

(51) Int. Cl. B32B 9/04; C08L 83/04; C08G 77/04

(52) U.S. Cl. 428/447; 528/29; 528/13

(57) ABSTRACT

The present invention accordingly provides new organopolysiloxanes having (meth)acrylic ester groups attached pendent and terminally or only pendent via SiOC groups, of the general average formula (I) 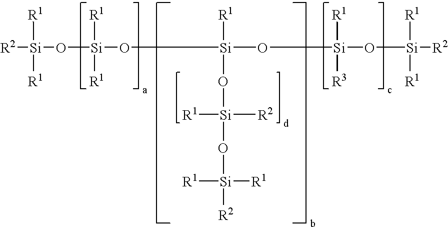 and also provides a process for preparing the compounds by reacting polysiloxanes containing SiH groups with (meth)acrylated monoalcohols and/or (meth)acrylated polyalcohols using Lewis-acidic catalysts or catalysts comprising a carboxylic acid and salts thereof.

The invention relates to new polysiloxanes containing (meth)acrylic ester groups attached via SiOC groups and to a process for the preparation, in which, using a catalyst, a hydrogen atom attached to the silicon is replaced by an alkoxide radical. The invention further relates to the use of these new organopolysiloxanes as radiation-curable coating compositions-for producing abhesive coatings.

Abhesive coating compositions are used widely to coat materials, especially sheetlike materials, in order to reduce the propensity of adherent products to adhere to said surfaces.

Abhesive coating compositions are used, for example, to coat papers or films which are to serve as backings for self-adhesive labels. The labels, provided with a pressure-sensitive adhesive, do adhere to the coated surface to a sufficient extent to allow handling. The adhesion of the adhesive labels to the backing must be sufficiently high that during the machine application of labels, to containers for example, the labels do not separate prematurely from their backing as it runs over deflection rolls. On the other hand, however, the labels must be able to be peeled from the coated backing without any substantial impairment to their bond strength for subsequent use. This requires particularly effective curing of the silicone release layer, since otherwise silicone components may transfer to the surface of the adhesive and reduce the bond strength.

Further possible applications for abhesive coating compositions are in packaging papers and packaging films which serve in particular for the packaging of sticky goods. Abhesive papers or films of this kind are used, for example, to pack foodstuffs or industrial products, such as bitumen.

A further application of abhesive coating compositions is in the production of self-stick closures, as for disposable diapers, for example. If the abhesiveness is too high, i.e., if the release force is too low, the diaper does not stay reliably closed. If the abhesiveness is too low and thus the release force is too high, the closure can no longer be opened without destructive tearing of the diaper.

For the function of the abhesive coating an important factor in all applications is the stability of the abhesiveness over long periods of time. There must not be any notable increase or decrease in the release force.

Since the nineteen-eighties there have been two radiation-curing abhesive coating compositions known on the market. One system, composed of epoxy-containing silicones, cures under UV radiation by a cationic curing mechanism. This system is described, inter alia, in US specifications U.S. Pat. Nos. 4,421,904; 4,547,431; 4,952,657; 5,217,805; 5,279,860; 5,340,898; 5,360,833; 5,650,453; 5,866,261 and 5,973,020.

The other system cures by a free radical polymerization mechanism following irradiation with UV or electron beams. Systems of this kind are described, for example, in US specifications U.S. Pat. Nos. 4,201,808, 4,568,566, 4,678,846, 5,494,979, 5,510,190, 5,552,506, 5,804,301, 5,891,530 and 5,977,282.

In systems which cure by a free radical mechanism the polymerizable groups are typically (meth)acrylic ester groups.

In the case of UV crosslinking, photoinitiators are added to the last-mentioned organosilicon compounds. Suitable photoinitiators are specified, inter alia, in J. P. Fouassier, “Polymerization photoinitiators: Excited state process and kinetic aspects”, Progress in Organic Coating, 18 (1990) 229-252”, in J. P. Fouassier, “Photochemical reactivity of UV radical photoinitiators of polymerisation: A general discussion”, Recent Res. Devel. Photochem. & Photobiol., 4(2000): 51-74, D. Ruhlmann et al, “Relations structure-proprietes dans les photoamorceurs de polymerisation-2. Derives de Phenyl Acetophenone”, Eur. Polym. J. Vol. 28, No. 3, pp. 287-292, 1992 and K. K. Dietliker, “Chemistry & Technology of UV & EB Formulation for Coatings, Inks & Paints”, Volume 3, Sita Technology Ltd, UK, and also in DE-10248111 and U.S. Pat. No. 4,347,111.

Also mentioned in the prior art are mixtures of two or more (meth)acrylated polysiloxanes with different chain lengths and/or types of modification (US-B-6 548 568, US-B-6 268 404, Goldschmidt publication “TEGO® RC Silicones, Application Guide”, Goldschmidt product data sheets for the products TEGO® RC 902, RC 726, RC 711, RC 708, RC 709, RC 715, RC 706). As compared with the individual components, such mixtures may offer, for example, the advantage of improved adhesion to the substrate, of controlled adjustment of abhesiveness or of a reduction or increase in viscosity.

To produce abhesive coatings normally a mixture of two or more of said organosilicon compounds is applied to sheetlike backings made of plastic, metal or paper and passed in web form from roll to roll at high machine speeds of several hundred meters per minute through an electron beam unit or a UV unit, and cured.

Polysiloxanes can be provided with (meth)acrylic ester groups in diverse ways. In order to attach organic groups to a siloxane there are in principle two different types of bonding available. In the first case a carbon atom is attached directly to a silicon atom (SiC linkage), while in the second case a carbon atom is attached via an oxygen atom to the silicon atom (SiOC linkage).

Organopolysiloxanes in which the acrylic ester-containing organic groups are joined to the polysiloxane backbone via Si—C-bonds are prior art. They may be prepared, for example, by subjecting a hydrosiloxane to addition reaction with allyl glycidyl ether or another suitable epoxide having an olefinic double bond and, following the addition reaction, esterifying the epoxide with acrylic acid to open the epoxide ring. This procedure is described in U.S. Pat. No. 4,978,726.

Another possibility of preparing (meth)acrylate-modified polysiloxanes with Si—C linkage of the modifying group(s) consists in subjecting a hydrosiloxane to addition reaction with an alcohol having an olefinic double bond, e.g., allyl alcohol, in the presence of a platinum catalyst and then reacting the OH group of this alcohol with acrylic acid or with a mixture of acrylic acid and other, saturated or unsaturated acids. This procedure is explained for example in U.S. Pat. No. 4,963,438.

Additionally it is possible in each case to bind two or more (meth)acrylate groups per linking member to the siloxane backbone. In order to achieve crosslinking of maximum effectiveness, in other words as great as possible a number of reactive groups, in conjunction with the least possible density of modification on the siloxane backbone, it is desirable to attach more than one (meth)acrylate group per bridging member. Processes of this kind are described for example in US-B-6 211 322.

All of these (meth)acrylate-modified organosiloxanes synthesized via SiC, which constitute the state of the art, have the disadvantage that they have to be prepared in multistage syntheses, resulting in high costs and a high level of technical complexity for the production operation.

For the formation of an SiOC linkage there are a number of methods available. Conventionally SiOC linkages are formed by reacting a siloxane with a leaving group (e.g., halogen), which is attached to the silicon atom, and with an alcohol.

Organopolysiloxanes where the (meth)acrylate-containing organic groups are joined via an Si—O—C bond to the polysiloxane backbone via a halogen leaving group are described in U.S. Pat. No. 4,301,268 and U.S. Pat. No. 4,306,050. Chlorosiloxanes in particular are widespread for this type of reaction.

Chlorosiloxanes, however, are difficult to handle, since they are extremely eager to react. The use of chlorosiloxanes is additionally associated with the disadvantage that the hydrogen chloride formed in the course of the reaction leads to environmental problems and restricts their handling to corrosion-resistant equipment. In the presence of chlorosiloxanes and alcohols, moreover, organic chloride compounds may be formed, which are undesirable on toxicological grounds.

Furthermore it is not simple to achieve quantitative conversion in the reaction of a chlorosiloxane with an alcohol. To obtain good conversions it is frequently necessary to employ bases which act as HCl scavengers. The use of these bases results in a large salt load, which in turn causes problems on the industrial scale, in the context of removal and disposal.

The stability of the Si—O—C bond over long periods of time is critical to the stability of the release behavior of an abhesive coating produced therefrom. Therefore there should be no reaction residues or catalyst residues remaining in the coating that are capable of catalyzing the hydrolysis of the SiOC bond. The processes referred to, however, produce acid residues or a salt load which cannot be removed completely from the reaction mixture. There remain in the abhesive coating catalytically active amounts which even after crosslinking may break down the SiOC bond. Moreover, the processes referred to allow access only to terminally modified organopolysiloxanes and hence do not provide any possibility of synthesizing organosiloxanes (meth)acrylate-modified pendent via SiOC.

In addition to the widespread preparation of terminal (α,ω)-organopolysiloxanes with chlorosiloxanes and alcohols a description is given in U.S. Pat. No. 5,310,842, for the synthesis of organopolysiloxanes modified pendent via SiOC chemistry, of the dehydrogenative hydrosilylation of long-chain and short-chain aliphatic alcohols to SiH siloxanes using Pt compounds and an organic acid as co-catalyst. This method is suitable, accordingly, for coupling different aliphatic alcohols dehydrogenatively to SiH siloxanes in terminal and pendent positions.

A similar procedure for a partial dehydrogenative hydrosilylation of SiH units with short-chain alcohols using Pt catalysts is described in US-B-6,359,097. The SiH units not fully reacted in this reaction are subsequently hydrosilylated with olefinic compounds.

For the skilled worker, however, it is readily evident that these above-described procedures are not practicable in the case of alcohols containing (meth)acrylic groups, since various Pt-catalyzed secondary reactions occur, such as an attachment of the double bond or carbonyl group of the (meth)acrylate groups to the SiH units (Journal of Polymer Science: Part A: Polymer Chemistry, Vol. 29, 1073-1076).

Furthermore, US-B-6 239 303 describes the dehydrogenative hydrosilylation of different alcohols to silanes using Ru catalysts with carbonyl ligands. This procedure too does not make it possible to carry out dehydrogenative hydrosilylation of alcohols containing (meth)acrylic groups to polysiloxanes, since Ru complexes likewise catalyze reaction of the (meth)acrylate groups with the SiH units.

Consequently the prior art does not provide any possibility for the synthesis of organosiloxanes (meth)acrylate-modified pendent via SiOC chemistry with defined structures. The known processes which lead to terminally (meth)acrylate-modified (via SiOC) organosiloxanes leave behind catalytic amounts of substances which break down SiOC bonds.

There was therefore a need to find a technically simple process which allows the preparation of new radiation-curable polysiloxanes, (meth)acrylate modified pendently and/or terminally via SiOC chemistry, without breakdown of the siloxane backbone.

Additionally the products obtained ought not to be contaminated, in contrast to the prior art processes, starting for example from chlorosiloxanes, with hydrochloric acid originating from the substitution reaction, or with chlorides corresponding to their neutralizations products, and hence the (meth)acrylate-modified polysiloxanes prepared ought to have higher stability of the SiOC bond to hydrolysis.

It has now surprisingly been found that using a Lewis-acidic catalyst or a mixture of a carboxylic acid and the salt of a carboxylic acid it is possible to couple (meth)acrylate-containing alcohols selectively onto terminal and/or pendent SiH siloxanes without any breakdown of the siloxane backbone or hydrosilylation of the (meth)acrylate groups to SiH groups being observed.

The present invention accordingly provides new organopolysiloxanes, having groups which carry (meth)acrylic esters attached pendent and terminally or only pendent, via SiOC groups, of the general average formula (I) 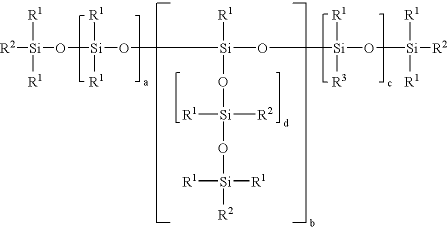
in which
R¹ radicals are identical or different and selected from linear or branched, saturated, mono- or polyunsaturated alkyl, aryl, alkaryl or aralkyl radicals having 1 to 20 carbon atoms,
R² radicals are identical or different radicals R¹ or R³,
R³ radicals are identical or different, singly or multiply (meth)acrylated monoalkoxylates or (meth)acrylated polyalkoxylates, or a mixture of the singly or multiply(meth)acrylated monoalkoxylates or polyalkoxylates with any desired other alkoxylates, selected from the group consisting of linear and branched, saturated, monounsaturated and polyunsaturated, aromatic, aliphatic-aromatic monoalcohols and polyalcohols, polyether mono-alcohols, polyether polyalcohols, polyester monoalcohols, polyester polyalcohols, aminoalcohols, especially N-alkylamino-and arylamino-ethylene oxide and propylene oxide alcohols, N-alkylamino and arylamino alkoxylates and also mixtures thereof, the ratio of the singly or multiply (meth)acrylated monoalkoxylates or polyalkoxylates to the arbitrary other alkoxylates being chosen such that at least one singly or multiply (meth)acrylated monoalkoxylate or polyalkoxylate radical is present in the organo-polysiloxane,
a is 0 to 1,000, preferably 0 to 500, especially 0 to 300,
b is 0 to 5,
c is 1 to 200, preferably 2 to 100, especially 3 to 80, and,
d is 0 to 1,000, preferably 0 to 500, especially 0 to 300.

The present invention further provides a process for preparing organopolysiloxanes having (meth)acrylic ester groups attached pendent and/or terminally via SiOC groups by reacting polysiloxanes containing SiH groups, of the general average formula (II)

in which

R¹ radicals are identical or different and selected from linear or branched, saturated, mono- or polyunsaturated alkyl, aryl, alkaryl or aralkyl radicals having 1 to 20 carbon atoms,
R² radicals are identical or different radicals R¹ or R³,
R³ radicals are identical or different, singly or multiply (meth)acrylated monoalkoxylates or (meth)acrylated polyalkoxylates, or a mixture of the singly or multiply(meth)acrylated monoalkoxylates or polyalkoxylates with any desired other alkoxylates, selected from the group consisting of linear and branched, saturated, monounsaturated and polyunsaturated, aromatic, aliphatic-aromatic monoalcohols and polyalcohols, polyether monoalcohols, polyether polyalcohols, polyester monoalcohols, polyester polyalcohols, aminoalcohols, especially N-alkylamino- and arylamino-ethylene oxide and propylene oxide alcohols, N-alkylamino and arylamino alkoxylates and also mixtures thereof, the ratio of the singly or multiply (meth)acrylated monoalkoxylates or polyalkoxylates to the arbitrary other alkoxylates being chosen such that at least one singly or multiply (meth)acrylated monoalkoxylate or polyalkoxylate radical is present in the organopolysiloxane,
a is 0 to 1,000, preferably 0 to 500, especially 0 to 300,
b is 0 to 5,
c is 1 to 200, preferably 2 to 100, especially 3 to 80, and,
d is 0 to 1,000, preferably 0 to 500, especially 0 to 300.

The present invention further provides a process for preparing organopolysiloxanes having (meth)acrylic ester groups attached pendent and/or terminally via SiOC groups by reacting polysiloxanes containing SiH groups, of the general average formula (II) 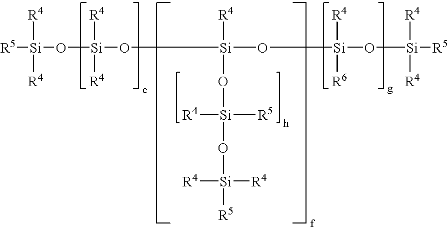
in which
R⁴ radicals are identical or different radicals selected from linear and branched, saturated, mono- and polyunsaturated alkyl, aryl, alkaryl and aralkyl radicals having 1 to 20 carbon atoms,
R⁵ is H or R⁴,
R⁶ is H,
e is 0 to 1,000,
f is 0 to 5,
g is 0 to 200 and
h is 0 to 1,000,
at least one radical R⁵ or R⁶ necessarily being H,
   with an alcohol selected from the group consisting of singly and multiply (meth)acrylated monoalcohols and polyalcohols, or of mixtures of singly or multiply (meth)acrylated monoalcohols or polyalcohols with any desired other alcohols selected from the group consisting of linear and branched, saturated, mono- and polyunsaturated, aromatic, aliphatic-aromatic monoalcohols and polyalcohols, polyether monoalcohols, polyether polyalcohols, polyester monoalcohols, polyester polyalcohols, amino alcohols, especially N-alkylamino- and N-arylamino-EO and -PO alcohols, N-alkylamino and N-arylamino alcohols and also mixtures thereof, which comprises replacing some or all of the existing SiH groups of the polysiloxane in one or more process steps, using a Lewis-acidic catalyst or a catalyst composed of a carboxylic acid and salts of carboxylic acids, by alkoxide radicals of the alcohols employed.

Preferred effective Lewis-acidic catalysts for the purposes of the present invention for compounds having not only terminal but also pendent (meth)acrylate radicals are the Lewis-acidic element compounds of main group III, especially element compounds containing borate and/or containing aluminum.

Among the Lewis-acidic element compounds of transition group 3 particular preference is given to Lewis acids containing scandium, yttrium, lanthanum and/or lanthanoids.

In accordance with the invention the element compounds of main group III and/or transition group 3 are used with particular preference in the form of halides, alkyl compounds, fluorine-containing, cycloaliphatic and/or heterocyclic compounds.

One preferred embodiment of the invention involves using fluorinated and/or unfluorinated organoboron compounds, particularly those selected from:
(C₅F₄) (C₆F₅)₂B; (C₅F₄)₃B; (C₆F₅)BF₂; BF(C₆F₅)₂; B(C₆F₅)₃; BCl₂(C₆F₅) BCl(C₆F₅)₂; B(C₆H₅) (C₆F₅)₂; B(Ph)₂(C₆F₅); [C₆H₄(mCF₃)]₃B; [C₆H₄(pOCF₃)]₃B; (C₆F₅)B(OH)₂; (C₆F₅)₂BOH; (C₆F₅)₂BH; (C₆F₅)BH₂; (C₇H₁₁)B(C₆F₅)₂; (C₈H₁₄B) (C₆F₅); (C₆F₅)₂B(OC₂H₅); (C₆F₅)₂B—CH₂CH₂Si (CH₃)₃; 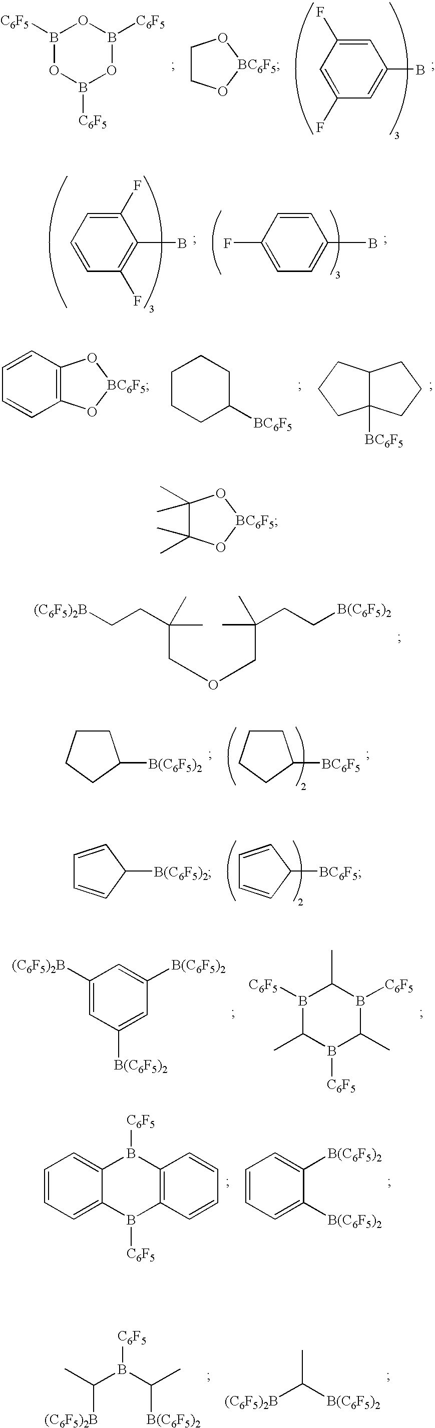
especially boron trifluoride etherate [109-63-7], borane-triphenylphosphine complex [2049-55-0], triphenylborane [960-71-4], tris(perfluorotriphenylborane) [1109-15-5], triethylborane [97-94-9] and boron trichloride [10294-34-5], tris(pentafluorophenyl)boroxine (9CI) [223440-98-0], 4,4,5,5-tetramethyl-2-(pentafluorophenyl)-1,3,2-dioxaborolane (9CI) [325142-81-2], 2-(pentafluorophenyl)-1,3,2-dioxaborolane (9CI) [336880-93-4], bis(pentafluorophenyl)cyclohexylborane [245043-30-5], di-2,4-cyclopentadien-1-yl(pentafluorophenyl)borane (9CI) [336881-03-9], (hexahydro-3a(1H)-pentalenyl)bis(penta-fluorophenyl)borane (9CI) [336880-98-9], 1,3-[2-[bis(penta-fluorophenyl)boryl]ethyl]tetramethyldisiloxane [336880-99-0], 2,4,6-tris(pentafluorophenyl)borazine (7CI, 8CI, 9CI) [1110-39-0], 1,2-dihydro-2-(pentafluorophenyl)-1,2-azaborine (9CI) [336880-94-5], 2-(pentafluorophenyl)-1,3,2-benzodioxaborole (9CI) [336880-96-7], tris(4-trifluoromethoxyphenyl)borane [336880-95-6], tris(3-trifluoromethylphenyl)borane [24455-00-3], tris(4-fluorophenyl)borane [47196-74-7], tris(2,6-difluorophenyl)borane [146355-09-1], tris(3,5-difluorophenyl)borane [154735-09-8] and also mixtures of the above catalysts.

The reactions of the terminal and/or pendent Si—H-functional siloxanes with the above-defined alcohols with boron-containing Lewis acids are carried out in accordance with the following general synthesis instructions:

The alcohol is introduced under inert gas, with or without solvent and the boron catalyst, and heated to 70° C. to 150° C. Subsequently the Si—H-functional siloxane is added dropwise and the reaction mixture is stirred until reaction is complete. The reaction regime can be modified by introducing the alcohol, the boron catalyst and the Si—H-functional siloxane, with or without solvent, and heating them to reaction temperature (one-pot reaction).

Additionally these reactions can be carried out using inert gas, lean air or inhibitors.

Further effective catalysts for the purposes of the present invention, especially for compounds containing terminal and/or pendent (meth)acrylate radicals, are mixtures of at least one acid and at least one salt of an acid, preferably mixtures of at least one organic acid, such as a carboxylic acid, dithiocarboxylic acid, aryl-/alkylsulfonic acid, aryl-/alkylphosphonic acid or aryl-/alkylsulfinic acid and at least one metal salt or ammonium salt of an organic acid, the metal cation being monovalent or polyvalent. The ratio of salt and acid can be varied in wide ranges, preference being given to a molar ratio of acid to salt in the range from 1:5 to 5:1, in particular from 2:3 to 3:2 mole equivalents. Additionally it is possible to use polyvalent acids or mixtures of monovalent and polyvalent acids and also the corresponding salts with monovalent or polyvalent cations. The pKa of the acid ought not to be negative, since otherwise there is equilibration of the siloxane backbone.

One particularly preferred embodiment of the invention consists in the use of catalytic systems composed of a 1:1 mixture of a carboxylic acid and its metal salt or ammonium salt, the metal being a main group element or transition metal, more preferably a metal from main group 1 or 2. The organic radical of the carboxylic acid is selected from cyclic, linear or branched, saturated, mono- or polyunsaturated alkyl, aryl, alkylaryl or arylalkyl radicals having 1 to 40, in particular 1 to 20, carbon atoms, haloalkyl groups having 1 to 40 carbon atoms, and hydroxyl-, carboxyl- or alkoxy-substituted alkyl, aryl, alkylaryl or arylalkyl radicals having 1 to 40 carbon atoms.

Particular preference is given to those systems whose carboxylic acid is selected from:

formic acid, acetic acid, propionic acid, butyric acid, valeric acid, caproic acid, oenanthic acid, caprylic acid, pelargonic acid, capric acid, undecanoic acid, lauric acid, myristic acid, palmitic acid, stearic acid, arachidic acid, behenic acid, cyclopentanecarboxylic acid, cyclohexanecarboxylic acid, acrylic acid, methacrylic acid, vinylacetic acid, crotonic acid, 2-/3-/4-penteneoic acid, 2-/3-/4-/5-hexeneoic acid, lauroleic acid, myristoleic acid, palmitoleic acid, oleic acid, gadoleic acid, sorbic acid, linoleic acid, linolenic acid, pivalic acid, ethoxyacetic acid, phenylacetic acid, lactic acid, hydroxycaproic acid, 2-ethylhexanoic acid, oxalic acid, malonic acid, succinic acid, malic acid, tartaric acid, citric acid, glutaric acid, adipic acid, pimelic acid, suberic acid, azelaic acid, sebacic acid, benzoic acid, o-/m-/p-toluic acid, salicylic acid, 3-/4-hydroxybenzoic acid, phthalic acids, or their fully or partly hydrogenated derivatives such as hexahydrophthalic or tetrahydrophthalic acid, or mixtures thereof.

The reactions of the terminal and/or pendent Si—H-functional siloxanes with the above-defined alcohols with mixtures of at least one acid and at least one salt of an acid are carried out in accordance with the following general synthesis instructions:

The alcohol is introduced with or without solvent and the catalyst (mixtures of at least one acid and at least one salt of an acid) and heated to 70° C. to 150° C. Subsequently the Si—H-functional siloxane is added dropwise and the reaction mixture is stirred until reaction is complete. The reaction regime can be modified by carrying out a one-pot reaction, in which the alcohol, the catalyst and the Si—H-functional siloxane, with or without solvent, are introduced initially.

These reactions may further be carried out using inert gas, oxygen-debted air or inhibitors.

Consequently, in an effort to overcome the disadvantages of the prior art, processes were provided which allow the preparation of polysiloxanes which are (meth)acrylate-modified terminally via SiOC chemistry and which exhibit excellent stability of the SiOC bond to hydrolysis. Additionally it has been possible to prepare polysiloxanes (meth)acrylated in middle pendent position, which were not accessible via SiOC chemistry in accordance with the prior art. The processes also make it possible to prepare (meth)acrylated polysiloxanes with mixed terminal and pendent modification via SiOC chemistry.

The (meth)acrylated polysiloxanes of the invention modified via SiOC chemistry can be prepared in a one step reaction with different chain lengths and/or types of modification, since preparation takes place without breakdown of the siloxane backbone.

For tailor-made products it is possible, further, to carry out any desired other reaction with the Si—H siloxane, in this context specifically a hydrosilylation, prior to the reaction of the alcohols with the Si—H siloxanes using the Lewis-acidic catalysts, in particular the boron catalysts, or the mixtures of at least one acid and at least one salt of an acid.

Mixtures of different polysiloxanes of the invention mixed with one another only after separate preparation are likewise possible.

Individual, or mixtures of, (meth)acrylated polysiloxanes of the invention modified via SiOC chemistry can be mixed in any desired ratio with any desired number of other (meth)acrylated polysiloxanes according to the prior art. Mixtures with epoxy-containing or vinyl ether-containing, UV-curing silicones are also possible.

The (meth)acrylated polysiloxanes of the invention modified via SiOC chemistry, or the stated mixtures, can additionally be mixed with further auxiliaries and additives according to the prior art. Mention may be made here in particular of photoinitiators, adhesion promoters, curing accelerators, photosensitizers, antioxidants, oxygen scavengers or organic compounds containing (meth)acrylic groups or vinyl ether groups. Further additives include dyes, pigments and solid particulate fillers.

The (meth)acrylated polysiloxanes of the invention modified via SiOC chemistry, or the stated mixtures, can be used to coat shaped articles and sheetlike supports for the purpose of producing, for example, abhesive coatings. They are crosslinked by free radicals and cure under the influence of
Heat, following addition of, for example, suitable thermally decomposing peroxides, or
Radiation such as light, including UV light, following addition of suitable photoinitiators, or
Electron beams
   within a very short time to form abhesive layers which are mechanically and chemically resistant.

### EXAMPLES

The examples which follow are intended to illustrate the invention, they do not constitute any restriction whatsoever.

Performance Testing:

To test the performance properties of the curable examples and mixtures of the examples they are applied, following the addition of 2% of the photoinitiator Darocur 1173 from Ciba Specialty, to sheetlike supports (oriented polypropylene film) and are cured by exposure to UV light from a state of the art medium-pressure mercury vapor lamp having a UV output of 50 W/cm under nitrogen inertization with a controlled residual oxygen content of <50 ppm and at a belt speed of 20 m/min. The application rate is in each case approximately 1 g/m².

Release Force:

The release force is determined using a 25 mm wide adhesive tape which has been coated with a rubber adhesive and is available commercially from Beiersdorf as TESA® 7476.

To measure the abhesiveness these adhesive tapes are rolled onto the substrate and then stored at 40° C. under a weight of 70 g/cm². After 24 hours a measurement is made of the force required to remove the respective adhesive tape from the substrate at a speed of 30 cm/min and a peel angle of 180°. This force is termed the release force. The general test procedure corresponds essentially to test method No. 10 of the Fédération Internationale des Fabricants et Transformateurs D'Adhésifs et Thermocollants sur Papier et autres Supports (FINAT).

Loop Test:

The loop test serves for rapid determination of the degree of cure of a release coating. For this test a strip of the adhesive tape TESA® 4154 from Beiersdorf approximately 20 cm long is rolled 3 times onto the substrate and immediately removed again by hand. Then, by placing the ends of the adhesive tape together, a loop is formed, so that the adhesive faces of both ends are in contact over a distance of approximately one centimeter. The ends are then pulled apart again by hand, in the course of which the contact area ought to migrate uniformly to the center of the adhesive tape. In the case of contamination with poorly cured release material, the bond strength of the adhesive tape is no longer sufficient to hold the contact area together when the ends are pulled apart. In this case the test is classed as failed.

Subsequent Adhesion:

The subsequent adhesion is determined very largely in accordance with FINAT test specification No. 11. For this purpose the adhesive tape TESA® 7475 from Beiersdorf is rolled onto the substrate and then stored at 40° C. under a weight of 70 g/cm². After 24 hours the adhesive tape is separated from the release substrate and rolled onto a defined substrate (steel plate, glass plate, film). After one minute a measurement is made of the force required to remove the adhesive tape from the substrate at a speed of 30 cm/min and a peel angle of 180°. The resulting measurement is divided by the value for the same measurement on an untreated adhesive tape under otherwise identical test conditions. The result is termed the subsequent adhesion and is expressed in general as a percentage. Figures above 80% are considered by the skilled worker to be sufficient, and suggest effective curing.

Rub-Off:

The rub-off test serves for rapid determination of the adhesive of the coating to the substrate. A single site on the coating is rubbed with the finger in 10 small circular motions, at constant pressure. The rub-off test is only carried out on coatings which have cured effectively. It is passed if no silicone constituents can be rubbed off.

Radiation-Curing Organosilicon Compounds:

### Example 1

Reaction of a Terminal Si—H-Functional Siloxane (e=7.2, R⁵═H) with 2-Hydroxyethyl Methacrylate (HEMA) Using a Boron Catalyst:

43.3 g of 2-hydroxyethyl methacrylate are heated to 90° C. in an inert atmosphere in a four-necked flask equipped with stirrer, highly efficient reflex condensor, thermometer and dropping funnel together with 0.043 g of tris(pentafluorophenyl)borane catalyst, 500 ppm of methylhydroquinone, 500 ppm of phenothiazine and 77.3 g of toluene. When the temperature has been reached 111.3 g of terminally Si—H-functionalized polydimethylsiloxane (e=7.2, R⁵═H) of the general formula HMe₂SiO(SiMe₂O)_{7.2}SiMe₂H are added dropwise over the course of 20 minutes. When addition is at an end, and after cooling, the conversion according to the SiH value method is 100%. Distillative removal of the volatile compounds gives a water-clear, colorless liquid which according to ¹H and ²⁹Si NMR spectra is assigned the general formula

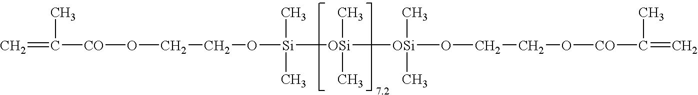

### Example 2

Reaction of a Terminal Si—H-Functional Siloxane (e=7.2, R⁵═H) with 2-Hydroxyethyl Acrylate (HEA) Using a Boron Catalyst:

46 g of 2-hydroxyethyl acrylate are heated to 90° C. in an inert atmosphere in a four-necked flask equipped with stirrer, highly efficient reflex condensor, thermometer and dropping funnel together with 0.051 g of tris(pentafluorophenyl)borane catalyst, 500 ppm of methylhydroquinone, 500 ppm of phenothiazine and 179.5 g of toluene. When the temperature has been reached 133.4 g of terminally Si—H-functionalized polydimethylsiloxane (e=7.2, R⁵=H) of the general formula HMe₂SiO(SiMe₂O)_{7.2}SiMe₂H are added dropwise over the course of 15 minutes. When addition is at an end, and after cooling, the conversion according to the SiH value method is 100%.

Distillative removal of the volatile compounds gives a water-clear, colorless liquid which according to ¹H and ²⁹Si NMR spectra is assigned the general formula

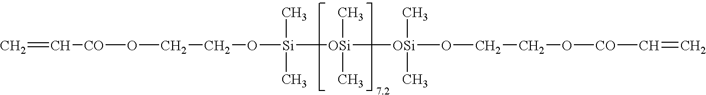

### Example 3

Reaction of a Terminal Si—H-Functional Siloxane (e=7.2, R⁵=H) with 2-hydroxypropyl acrylate (HPA) using a boron catalyst:

27.3 g of 2-hydroxypropyl acrylate are heated to 90° C. in an inert atmosphere in a four-necked flask equipped with stirrer, highly efficient reflex condensor, thermometer and dropping funnel together with 0.039 g of tris(pentafluorophenyl)borane catalyst, 300 ppm of methylhydroquinone and 47 g of toluene. When the temperature has been reached 66.75 g of terminally Si—H-functionalized polydimethylsiloxane (e=7.2, R⁵═H) of the general formula HMe₂SiO(SiMe₂O)_{7.2}SiMe₂H are added dropwise over the course of 15 minutes. When addition is at an end, and after cooling, the conversion according to the SiH value method is 100%.

Distillative removal of the volatile compounds gives a water-clear, colorless liquid.

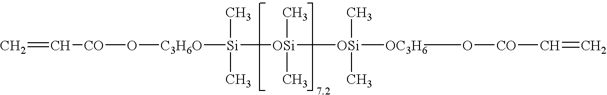

### Example 4

Reaction of a Pendent Si—H-Functional Siloxane (e=13, g=5, R⁵=Me) with 2-Hydroxyethyl Acrylate Using a Boron Catalyst:

60.9 g of 2-hydroxyethyl acrylate are heated to 90° C. in an inert atmosphere in a four-necked flask equipped with stirrer, highly efficient reflex condenser, thermometer and dropping funnel together with 0.38 g of tris(pentafluorophenyl)borane catalyst, 300 ppm of methylhydroquinone and 102 g of toluene. When the temperature has been reached 142.8 g of pendent Si—H-functionalized polydimethylsiloxane (e=13, g=5, R⁵=Me) of the general formula HMe₂SiO(SiMeHO)₅(SiMe₂O)₁₃SiMe₂H (SiH: 0.353%) are added dropwise over the course of 15 minutes. When addition is at an end, and after cooling, the conversion according to the SiH value method is 100%.

Distillative removal of the volatile compounds gives a colorless liquid.

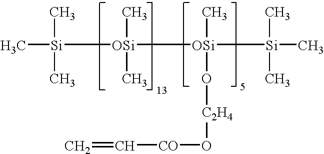

### Example 5

Reaction of a Pendent Si—H-Functional Siloxane (e=200, g=5, R⁵=Me) with 2-Hydroxyethyl Acrylate Using a Boron Catalyst:

13.7 g of 2-hydroxyethyl acrylate are heated to 90° C. in an inert atmosphere in a four-necked flask equipped with stirrer, highly efficient reflex condensor, thermometer and dropping funnel together with 0.046 g of tris(pentafluorophenyl)borane catalyst, 300 ppm of methylhydroquinone and 154.6 g of toluene. When the temperature has been reached 295.5 g of pendent Si—H-functionalized polydimethylsiloxane (e=200, g=5, R⁵=Me) of the general formula HMe₂SiO(SiMeHO)₅(SiMe₂O)₂₀₀SiMe₂H (SiH value: 0.031%) are added dropwise over the course of 15 minutes. When addition is at an end, and after cooling, the conversion according to the SiH value method is 100%.

Distillative removal of the volatile compounds gives a colorless liquid.

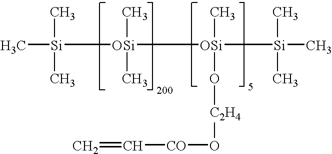

### Example 6

Reaction of a Terminal Si—H-Functional Siloxane (e=18, R⁵═H) with 2-Hydroxyethyl Acrylate Using a Boron Catalyst:

116.1 g of 2-hydroxyethyl acrylate are heated to 90° C. in an inert atmosphere in a four-necked flask equipped with stirrer, highly efficient reflex condensor, thermometer and dropping funnel together with 0.512 g of tris(pentafluorophenyl)borane catalyst, 300 ppm of methylhydroquinone and 526.6 g of toluene. When the temperature has been reached 725.1 g of terminally Si—H-functionalized polydimethylsiloxane (e=18, R⁵=H) of the general formula HMe₂SiO(SiMe₂O)₁₈SiMe₂H (SiH value: 0.139%) are added dropwise over the course of 15 minutes. When addition is at an end, and after cooling, the conversion according to the SiH value method is 100%.

Distillative removal of the volatile compounds gives a water-clear, colorless liquid.

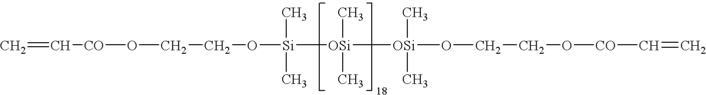

### Example 7

Reaction of a Terminal Si—H-Functional Siloxane (e=98, R⁵=H) with 2-Hydroxyethyl Acrylate Using a Boron Catalyst:

50.3 g of 2-hydroxyethyl acrylate are heated to 90° C. in an inert atmosphere in a four-necked flask equipped with stirrer, highly efficient reflex condensor, thermometer and dropping funnel together with 0.171 g of tris(pentafluorophenyl)borane catalyst, 300 ppm of methylhydroquinone and 256.6 g of toluene. When the temperature has been reached 1.233 g of terminally Si—H-functionalized polydimethylsiloxane (e=98, R⁵=H) of the general formula HMe₂SiO(SiMe₂O)₉₈SiMe₂H (SiH value: 0.0272%) are added dropwise over the course of 15 minutes. When addition is at an end, and after cooling, the conversion according to the SiH value method is 100%.

Distillative removal of the volatile compounds gives a water-clear, colorless liquid.

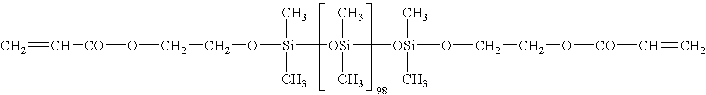

### Example 8

Reaction of a Pendent and Terminal Si—H-Functional Siloxane (e=166, g=10, R⁵=H) with 2-Hydroxyethyl Acrylate Using a Boron Catalyst:

15.7 g of 2-hydroxyethyl acrylate are heated to 90° C. in an inert atmosphere in a four-necked flask equipped with stirrer, highly efficient reflex condensor, thermometer and dropping funnel together with 0.053 g of tris(pentafluorophenyl)borane catalyst, 300 ppm of methylhydroquinone and 83.4 g of toluene. When the temperature has been reached 123.3 g of terminally and pendent Si—H-functionalized polydimethylsiloxane (e=166, g=10, R⁵═H) of the general formula HMe₂SiO(SiMeHO)₁₀(SiMe₂O)₁₆₆SiMe₂H (SiH value: 0.081%) are added dropwise over the course of 15 minutes. When addition is at an end, and after cooling, the conversion according to the SiH value method is 100%.

Distillative removal of the volatile compounds gives a colorless, slightly turbid liquid.

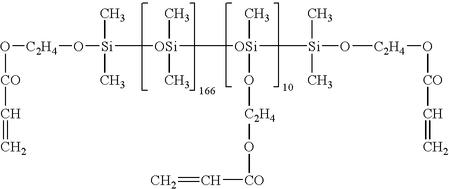

### Example 9

Reaction of a Terminal Si—H-Functional Siloxane (e=98, R⁵═H) with Pentaerythrityl Triacrylate (PETTriA) Using a Boron Catalyst:

99.5 g of pentaerythrityl triacrylate are heated to 90° C. in an inert atmosphere in a four-necked flask equipped with stirrer, highly efficient reflex condensor, thermometer and dropping funnel together with 0.085 g of tris(pentafluorophenyl)borane catalyst, 500 ppm of methylhydroquinone and 616.5 g of toluene. When the temperature has been reached 616.5 g of terminally Si—H-functionalized polydimethylsiloxane (e=98, R⁵═H) of the general formula HMe₂SiO(SiMe₂O)₉₈SiMe₂H (SiH value: 0.0272%) are added dropwise over the course of 30 minutes. When addition is at an end, and after cooling, the conversion according to the SiH value method is 100%.

Distillative removal of the volatile compounds gives a colorless liquid.

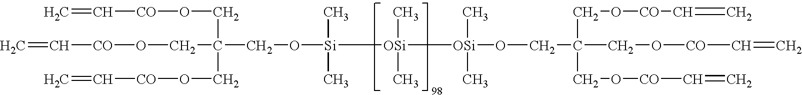

### Example 10

Reaction of a Terminal Si—H-Functional Siloxane (e=7.2, R⁵=H) with Hydroxyethyl Acrylate (HEA) Using a Catalytic Mixture Composed of Cesium Laurate/Lauric Acid:

25.6 g of HEA are heated to 120° C. in a four-necked flask equipped with stirrer, highly efficient reflex condensor, thermometer and dropping funnel together with 2.9 g of cesium laurate/lauric acid catalyst, 500 ppm of methylhydroquinone and 500 ppm of phenothiazine. After one hour 66.7 g of terminally Si—H-functionalized polydimethylsiloxane (e=7.2, R⁵═H) of the general formula HMe₂SiO(SiMe₂O)₇₂SiMe₂H are added dropwise over the course of 30 minutes and stirring is continued at 120° C. for 6 h. The conversion according to the SiH value method was determined as being 99.4% and the catalyst was removed by simple filtration using a fluted filter.

Distillative removal of the volatile reaction byproducts gives a clear, yellow liquid which according to ¹H and ²⁹Si NMR spectra is assigned the general formula

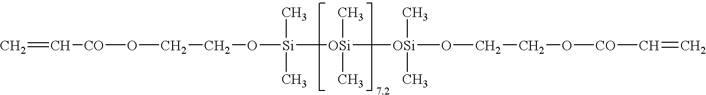

### Example 11

Reaction of a Terminal Si—H-Functional Siloxane (e=18, R⁵═H) with an Acrylated Polyether (Bisomer® PEA 6, Cognis) Using a Boron Catalyst:

328.1 g of Bisomer PEA 6 are heated to 90° C. in an inert atmosphere in a four-necked flask equipped with stirrer, highly efficient reflex condensor, thermometer and dropping funnel together with 0.512 g of tris(pentafluorophenyl)borane catalyst, 500 ppm of methylhydroquinone, 500 ppm of phenothiazine and 526.6 g of toluene. When the temperature has been reached 725.1 g of terminally Si—H-functionalized polydimethylsiloxane (e=18, R⁵=H) of the general formula HMe₂SiO(SiMe₂O)₁₈SiMe₂H (SiH value: 0.139%) are added dropwise over the course of 15 minutes. When addition is at an end, and after cooling, the conversion according to the SiH value method is 100%.

Distillative removal of the volatile compounds gives a water-clear, colorless liquid.

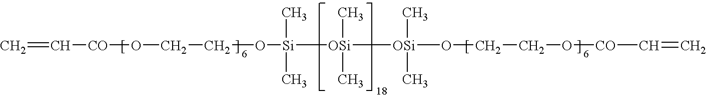

### Comparative Example 12

Reaction of a Terminal Si—Cl-Functional Siloxane (n=100) with Pentaerithrityl Triacrylate Using Triethylamine:

29.8 g of pentaerithrityl triacrylate are heated to 90° C. in an inert atmosphere in a four-necked flask equipped with stirrer, highly efficient reflex condensor, thermometer and dropping funnel, together with 500 ppm of methylhydroquinone and 500 ppm of phenothiazine. When the temperature has been reached 327.8 g of terminally Si—Cl-functionalized polydimethylsiloxane (e=98, R⁵=Cl) of the general formula ClMe₂SiO(SiMe₂O)₉₈SiMe₂Cl are added dropwise over the course of 30 minutes and the resultant HCl is stripped off by applying a vacuum. After a reaction time of 1 h the product is neutralized with triethylamine, diluted with toluene and filtered. Distillative removal of the volatile compounds gives a pale yellow liquid.

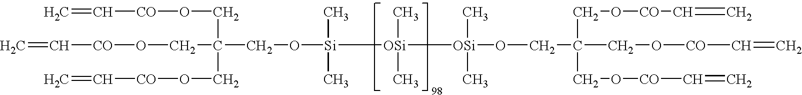

### Comparative Example 13

Reaction of a Terminal Si—Cl-Functional Siloxane (n=20) with 2-Hydroxyethyl Acrylate Using Triethylamine:

23.2 g of 2-hydroxyethyl acrylate are heated to 90° C. in an inert atmosphere in a four-necked flask equipped with stirrer, highly efficient reflex condensor, thermometer and dropping funnel, together with 500 ppm of methylhydroquinone and 500 ppm of phenothiazine. When the temperature has been reached 116 g of terminally Si—Cl-functionalized polydimethylsiloxane (e=18, R⁵=Cl) of the general formula ClMe₂SiO(SiMe₂O)₁₈SiMe₂Cl are added dropwise over the course of 30 minutes and the resultant HCl is stripped off by applying a vacuum. After a reaction time of 1 h the product is neutralized with triethylamine, diluted with toluene and filtered. Distillative removal of the volatile compounds gives a pale yellow liquid.

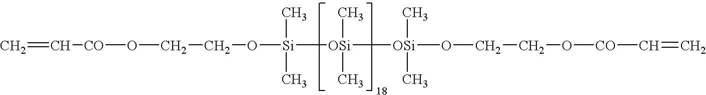

### Comparative Example 14

As a comparative example of an organopolysiloxane where the acrylic ester-containing organic groups are connected to the polysiloxane backbone by terminal Si—C bonds use is made of TEGO® RC 706 from Goldschmidt (in accordance with DE-A-38 20 294).

Comparative Example 15

As a further comparative example of an organopolysiloxane where the acrylic ester-containing organic groups are connected to the polysiloxane backbone by terminal Si—C bonds use is made of PC 911 from Rhodia (in accordance with DE-A-38 20 294).

### Comparative Example 16

As a further comparative example of an organopolysiloxane where the acrylic ester-containing organic groups are connected to the polysiloxane backbone by terminal Si—C bonds TEGO® RC 902 (in accordance with U.S. Pat. No. 6,211,322) has a very good abhesive effect against sticky substances in the cured coating. The amount of double bonds capable of polymerization is very low. TEGO® RC 902 is blended, to improve its substrate adhesion, with TEGO® RC 711 (according DE-A-38 20 294). As comparative example 16 use was made of a 70:30 RC 902/RC 711 mixture.

### Comparative Example 17

As a further comparative example of an organopolysiloxane where the acrylic ester-containing organic groups are connected to the polysiloxane backbone by terminal Si—C bonds use is made of a particularly long-chain but highly functionalized compound, according to U.S. Pat. No. 6,211,322. This compound was obtained from Goldschmidt as an experimental product and according to ¹H and ²⁹Si NMR spectra has a chain length of approximately 400 siloxane units with terminal functionality, having more than one acrylate group per chain end.

The inventive examples 1 to 11 and also the examples 12 and 13 likewise functionalized via SiOC bonds are summarized again in the following table.

| Example 1 | R³H = | R² = | a | c |
|---|---|---|---|---|
| 1 | HEMA | R³ | 7.2 | 0 |
| 2 | HEA | R³ | 7.2 | 0 |
| 3 | HPA | R³ | 7.2 | 0 |
| 4 | HEA | R¹ | 13 | 5 |
| 5 | HEA | R¹ | 200 | 5 |
| 6 | HEA | R³ | 18 | 0 |
| 7 | HEA | R³ | 98 | 0 |
| 8 | HEA | R³ | 166 | 10 |
| 9 | PETTriA | R³ | 98 | 0 |
| 10 | HEA | R³ | 7.2 | 0 |
| 11 | Bisomer ® PEA 6 | R³ | 18 | 0 |
| 12 | PETTriA | R³ | 98 | 0 |
| 13 | HEA | R³ | 18 | 0 |

Examples 1 to 15 were tested as they were as described under “Performance testing”. Example 16 was tested in the form of the mixture stated. The results (release force, loop test, rub-off and subsequent adhesion, carried out as described) are summarized in the table below:

| | Release force | LOOP test | Subsequent | Rub-off |
|---|---|---|---|---|
| | TESA 7476 | passed | adhesion | passed |
| Example | [cN/inch] | yes/no | [%] | yes/no |
| 1 | 50 | no | 50 | nA |
| 2 | 210 | yes | 96 | yes |
| 3 | 223 | yes | 93 | yes |
| 4 | 350 | yes | 92 | yes |
| 5 | 35 | yes | 84 | no |
| 6 | 163 | yes | 92 | yes |
| 7 | 55 | yes | 93 | no |
| 8 | 49 | yes | 88 | no |
| 9 | 55 | yes | 96 | no |
| 10 | 229 | yes | 96 | yes |
| 11 | 152 | yes | 90 | yes |
| 12 | 52 | yes | 79 | no |
| 13 | 145 | yes | 82 | yes |
| 14 | 160 | yes | 95 | yes |
| 15 | 60 | yes | 69 | no |
| 16 | 45 | yes | 93 | yes |
| 17 | 30 | no | 50 | nA |

nA: not applicable

From performance testing it is apparent that comparable siloxane backbone exhibit comparable properties, irrespective of whether the functionalization has been undertaken via SiC or SiOC (e.g., Examples 3, 6, 11 and 14).

Additionally mixtures of the inventive examples were prepared and tested above:

| | Release | | | |
|---|---|---|---|---|
| | force | LOOP test | Subsequent | Rub-off |
| | TESA 7476 | passed | adhesion | passed |
| Mixture Example | [cN/inch] | yes/no | [%] | yes/no |
| 2/5 | 42 | yes | 85 | yes |
| 30:70% | | | | |
| 4/5 | 48 | yes | 86 | yes |
| 30:70% | | | | |
| 4/8/5 | 45 | yes | 89 | yes |
| 30:50:20% | | | | |
| 4/8/5 | 53 | yes | 96 | yes |
| 30:65:5% | | | | |
| 4/9 | 53 | yes | 92 | yes |
| 30:70% | | | | |
| 4/15 | 63 | yes | 96 | yes |
| 30:70% | | | | |
| 5/8/17 | 35 | yes | 96 | yes |
| 30:67:3% | | | | |

Performance testing of the mixtures indicates that by combining different chain lengths and types of modification of terminal and/or pendent modified (meth)acrylated polysiloxanes it is possible to achieve very good properties. The properties are comparable with those that are currently the benchmark in the state of the art (comparative example 16).

The necessity of mixing the compounds of the invention can be avoided by reacting mixtures of the corresponding SiH-functional siloxane backbone together in one reaction step. This is possible because there is no breakdown of the siloxane backbone.

Additionally the blending of noninventive compounds with inventive compounds can bring advantages (compare example 15 with the mixture from example 4 and 15). By this means it is possible, as shown, to improve the adhesion properties.

Furthermore it is possible to blend mixtures of the inexpensively preparable compounds of the invention additionally with generally small amounts, from 1 to 20% for example, of very long-chain but highly functionalized compounds, prepared in accordance with U.S. Pat. No. 6,211,322. This produces particularly abhesive release coatings having very good long-term stability and very uniform release behavior without an increased release-force peak at the beginning of the release operation, and with little variation in the release force during the release operation (also called “zip”) (mixture of examples 5/8/17 30:67:3%).

1. An organopolysiloxane having groups which carry (meth)acrylic esters attached pendent and terminally or only pendent via SiOC groups, of the general average formula (I) 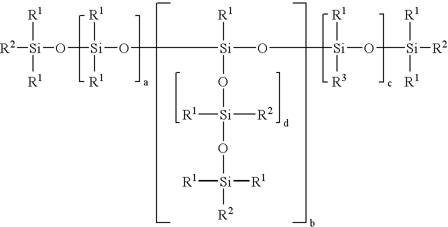
in which
R¹ radicals are identical or different and selected from linear or branched, saturated, mono- or polyunsaturated alkyl, aryl, alkaryl or aralkyl radicals having 1 to 20 carbon atoms,
R² radicals are identical or different radicals R¹ or R³,
R³ radicals are identical or different, singly or multiply (meth)acrylated monoalkoxylates or (meth)acrylated polyalkoxylates, or a mixture of the singly or multiply(meth)acrylated monoalkoxylates or polyalkoxylates with any desired other alkoxylates, selected from the group consisting of linear and branched, saturated, monounsaturated and polyunsaturated, aromatic, aliphatic-aromatic monoalcohols and polyalcohols, polyether monoalcohols, polyether polyalcohols, polyester monoalcohols, polyester polyalcohols, aminoalcohols, especially N-alkylamino- and arylamino-ethylene oxide- and propylene oxide alcohols, N-alkylamino and arylamino alkoxylates and also mixtures thereof, the ratio of the singly or multiply (meth)acrylated monoalkoxylates or polyalkoxylates to the arbitrary other alkoxylates being chosen such that at least one singly or multiply (meth)acrylated monoalkoxylate or polyalkoxylate radical is present in the organopolysiloxane,
a is 0 to 1,000,
b is 0 to 5,
c is 1 to 200,
d is 0 to 1,000.

2. A process for preparing an organopolysiloxane having (meth)acrylic ester groups attached pendent and/or terminally via SiOC groups by reacting a polysiloxane containing SiH groups and of the general average formula (II) 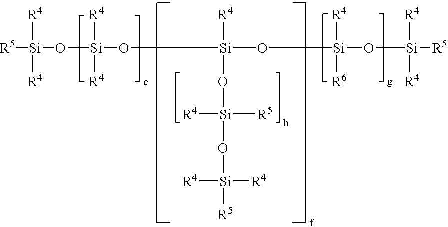
in which
R⁴ radicals are identical or different radicals selected from linear and branched, saturated, mono- and polyunsaturated alkyl, aryl, alkaryl and aralkyl radicals having 1 to 20 carbon atoms, with the proviso that at least one of the radicals R⁵ or R⁶ is hydrogen,
R⁵ is H or R⁴,
R⁶ is H,
e is 0 to 1,000,
f is 0 to 5,
g is 0 to 200 and
h is 0 to 1,000,
with an alcohol selected from the group consisting of singly and multiply (meth)acrylated monoalcohols and polyalcohols, or of mixtures of singly or multiply (meth)acrylated monoalcohols or polyalcohols with any desired other alcohols selected from the group consisting of linear and branched, saturated, mono- and polyunsaturated, aromatic, aliphatic-aromatic monoalcohols and polyalcohols, polyether monoalcohols, polyether polyalcohols, polyester monoalcohols, polyester polyalcohols, amino alcohols, especially N-alkylamino- and N-arylamino-EO and -PO alcohols, N-alkylamino and N-arylamino alcohols and also mixtures thereof, which comprises replacing some or all of the existing SiH groups of the polysiloxane in one or more process steps, using a Lewis-acidic catalyst or a catalyst composed of a carboxylic acid and salts of carboxylic acids, by alkoxide radicals of the alcohols employed.

3. A process for preparing an organopolysiloxane as claimed in claim 2, wherein use is made as catalyst of at least one compound selected from the group consisting of (C₅F₄)(C₆F₅)₂B; (C₅F₄)₃B; (C₆F₅)BF₂; BF(C₆F₅; B(C₆F₅)₃; BCl₂(C₆F₅); BCl(C₆F₅)₂; B(C₆H₅)(C₆F₅; B(Ph)₂(C₆F₅); [C₆H₄(mCF₃)]₃; [C₆H₄(pOCF₃)]₃B; (C₆F₅)B(OH)₂; (C₆F₅)₂BOH; (C₆F₅)₂BH; (C₆F₅)BH₂; (C₇H₁₁)B(C₆F₅)₂; (C₈H₁₄B)(C₆F₅); (C₆F₅)B(OC₂H₅); (C₆F₅)B—CH₂CH₂Si(CH₃)₃; 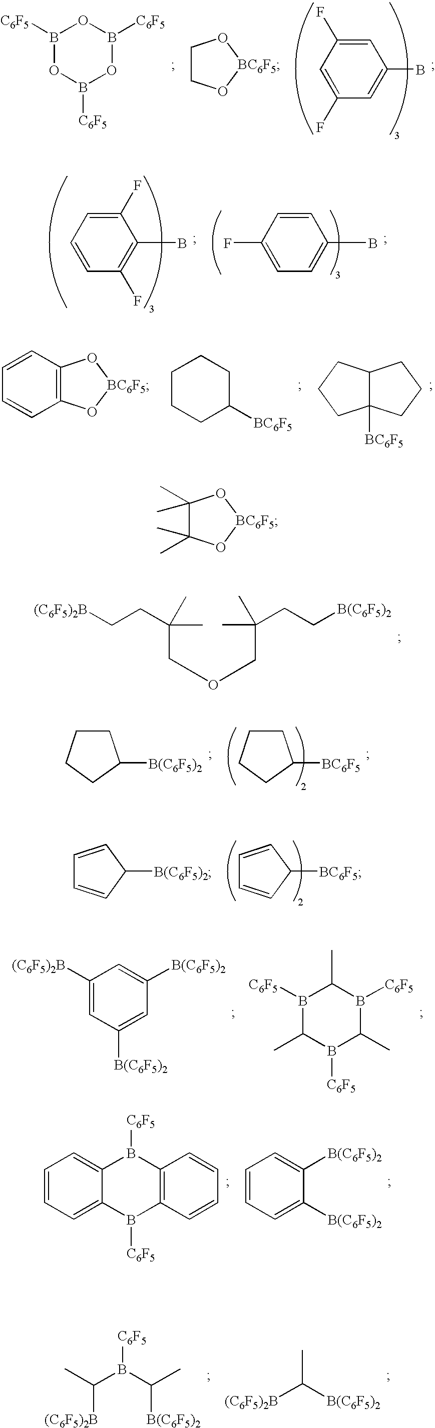
especially boron trifluoride etherate, borane-triphenylphosphine complex, triphenylborane, tris(perfluorotriphenylborane), triethylborane and boron trichloride, tris(pentafluorophenyl)boroxine (9CI), 4,4,5,5-tetramethyl-2-(pentafluorophenyl)-1,3,2-dioxaborolane (9CI), 2-(pentafluorophenyl)-1,3,2-dioxaborolane (9CI), bis(pentafluoro-phenyl)cyclohexylborane, di-2,4-cyclopentadien-1-yl(pentafluorophenyl)borane (9CI), (hexahydro-3a(1H)-pentalenyl)bis(pentafluorophenyl)borane (9CI), 1,3-[2-[bis(penta-fluorophenyl)boryl]ethyl]tetramethyldisiloxane, 2,4,6-tris(pentafluorophenyl)borazine (7CI, 8CI, 9CI), 1,2-dihydro-2-(pentafluorophenyl)-1,2-azaborine (9CI), 2-(penta-fluorophenyl)-1,3,2-benzodioxaborole (9CI), tris(4-trifluoromethoxyphenyl)borane, tris(3-trifluoromethylphenyl)borane, tris(4-fluorophenyl)borane, tris(2,6-difluorophenyl)borane, tris(3,5-difluorophenyl)borane and also mixtures of the above catalysts.

4. A process for reacting a polysiloxane containing SiH groups, as claimed in claim 2, wherein it is possible to operate both solvent-free and using a solvent.

5. A process as claimed in claim 2, which is a single-stage synthesis.

6. A process as claimed in claim 2, wherein use is made as alcohols of 2-hydroxyethyl(meth)acrylate, hydroxypropyl (meth)acrylate, hydroxybutyl(meth)acrylate, hydroxypentyl(meth)acrylate, hydroxy-hexyl (meth)acrylate, hydroxypolyether (meth)acrylate, hydroxymonoester (meth)acrylic esters, hydroxypolyester (meth)acrylic esters, pentaerythrityl tri(meth)acrylate, pentaerithrityl di(meth)acrylate and propanetrimethylol di-(meth)acrylate or mixtures of the aforementioned (meth)acrylated and poly(meth)acrylated alcohols with any desired other alcohols or polyols.

7. The process as claimed in claim 2, wherein α,ω-polysiloxanes with f=0, g=0 and R⁵=H are used.

8. The process as claimed in claim 2, wherein mixtures of different SiH polysiloxanes with the singly or multiply (meth)acrylate monoalcohols or polyalcohols, or with the mixtures of the singly or multiply (meth)acrylated monoalcohols or polyalcohols with any desired other alcohols, selected from the group consisting of linear and branched, saturated, mono- and polyunsaturated, aromatic, aliphatic-aromatic monoalcohols and polyalcohols, polyether monoalcohols and polyether polyalcohols, polyester monoalcohols, poly-ester polyalcohols, amino alcohols, especially N-alkylamino- and N-arylamino-EO- and -PO alcohols, N-alkylamino and N-arylamino alcohols, and also mixtures thereof.

9. A process as claimed in claim 2, wherein for siloxane compounds having terminal or pendent (meth)acrylic groups use is made as catalysts, instead of the catalysts there, of mixtures of at least one acid and at least one salt of an acid and at least one metal salt or ammonium salt of an organic acid, the metal cation being monovalent or polyvalent.

10. The process as claimed in claim 9, wherein as catalysts use is made of mixtures of a carboxylic acid, dithiocarboxylic, aryl-/alkylsulfonic acid, aryl-/alkylphosphonic acid or aryl-/alkylsulfinic acid and at least one metal salt or ammonium salt of an organic acid, the metal cation being monovalent or polyvalent.

11. The process as claimed in claim 2, wherein any other desired reaction with the Si—H siloxane, in this context specifically a hydrosilylation, is carried out before the alcohols are reacted with the Si—H siloxanes using the Lewis-acidic catalysts or the mixtures of at least one acid and at least one salt of an acid.

12. A curable abhesive coating composition comprising at least one compound as claimed in claim 1.

13. A curable abhesive coating composition as claimed in claim 12, wherein (meth)acrylated polysiloxanes with mixed terminal and pendent modification are used.

14. A curable abhesive coating composition as claimed in claim 12, wherein mixtures of different chain lengths and types of modification of (meth)acrylated polysiloxanes modified terminally and/or pendently are used.

15. A curable abhesive coating composition as claimed in claim 12, which is prepared in one single synthesis stage.

16. A curable abhesive coating composition as claimed in claim 12, wherein mixtures of modified (meth)acrylate polysiloxanes with other, noninventive radiation-curing polysiloxanes are used.

17. A curable abhesive coating composition as claimed in claim 12, wherein auxiliaries and additives according to the prior art are mixed in, in particular one or more selected from the group consisting of photoinitiators, adhesion promoters, curing accelerators, photosensitizers, antioxidants, oxygen scavengers, organic compounds containing (meth)acrylic groups or organic compounds containing vinyl ether groups, and also dyes, pigments and solid particulate fillers.

18. The use of a curable coating composition as claimed in claim 12 for coating shaped articles and sheetlike supports.

19. An abhesive coating produced by curing a curable coating composition as claimed in claim 12.

20. An abhesive coating as claimed in claim 19, wherein curing takes place using heat or radiation.
